(19) United States
(12) Patent Application Publication
(10) Pub. No.: US 2022/0030973 A1
(43) Pub. Date: Feb. 3, 2022

(54) FACE MASKS, FACE MASKS CONVERTIBLE TO HAIR ACCESSORIES, AND METHODS OF MAKING THE SAME

(71) Applicant: Elizabeth Ann Floersheimer, Chicago, IL (US)

(72) Inventor: Elizabeth Ann Floersheimer, Chicago, IL (US)

(21) Appl. No.: 17/393,041

(22) Filed: Aug. 3, 2021

Related U.S. Application Data
(60) Provisional application No. 63/060,495, filed on Aug. 3, 2020.

(51) Int. Cl. A41D 13/11; A62B 23/02; A45D 8/00; A41D 15/04

(52) U.S. Cl. CPC A41D 13/1161; A41D 15/04; A45D 8/00; A62B 23/025

(57) ABSTRACT

A face mask includes a first fabric panel, a second fabric panel, a first channel, a second channel, and a cord. The second fabric panel is coupled to the first fabric panel. The second fabric panel has a first pair of apertures and a second pair of apertures. The first channel is positioned generally between a first one of the first pair of apertures and a first one of the second pair of apertures. The second channel is positioned generally between a second one of the first pair of apertures and a second one of the second pair of apertures. The cord is positioned through the first one of the first pair of apertures, through the first channel, out of the first one of the second pair of apertures, through the second one of the second pair of apertures, through the second channel, and out of the second one of the first pair of apertures.

### CROSS-REFERENCE TO RELATED APPLICATIONS

This application claims the benefit of and priority to U.S. Provisional Application No. 63/060,495, filed Aug. 3, 2020, which is hereby incorporated by reference herein in its entirety.

### TECHNICAL FIELD

This disclosure relates to devices to cover a portion of an individual face and more specifically to face masks, face masks that are convertible into hair accessories, and methods of making the same.

### BACKGROUND

In order to slow or stop the spread of germs and disease from human to human, humans can wear face masks. In such situations, the individual needs to remember to bring their face mask to situations where the face mask is needed. When the face mask is not needed to be worn, it needs to be held and/or put in a safe location.

The present disclosure is directed to solving these problems and addressing other needs.

### SUMMARY

According to some implementations of the present disclosure, a device is convertible between a face mask and a hair accessory. The device includes a first fabric panel, a second fabric panel, a first pair of aperture reinforcements, a second pair of aperture reinforcements, a first channel, a second channel, and a cord. The first fabric panel has an upper edge, a lower edge, a first side edge, and a second side edge. The second fabric panel has an upper edge, a lower edge, a first side edge, and a second side edge. The second fabric panel is coupled to the first fabric panel about at least a portion of a perimeter of the device. The second fabric panel has a first pair of apertures adjacent to the first side edge of the second fabric panel and a second pair of apertures adjacent to the second side edge of the second fabric panel. The first pair of aperture reinforcements is coupled to the second fabric panel about the first pair of apertures. The second pair of aperture reinforcements is coupled to the second fabric panel about the second pair of apertures to aid in reinforcing the first and second pairs of apertures in the second fabric panel. The first channel is positioned generally along at least a portion of the upper edge of the first fabric panel and at least a portion of the upper edge of the second fabric panel such that a first one of the first pair of apertures is in communication with a first one of the second pair of apertures via the first channel. The second channel is positioned generally along at least a portion of the lower edge of the first fabric panel and at least a portion of the lower edge of the second fabric panel such that a second one of the first pair of apertures is in communication with a second one of the second pair of apertures via the second channel. The cord is positioned through the first one of the second pair of apertures, through the first channel, out of the first one of the first pair of apertures, through the second one of the first pair of apertures, through the second channel, and out of the second one of the second pair of apertures.

According to some implementations of the present disclosure, a face mask includes a first fabric panel, a second fabric panel, a first channel, a second channel, and a cord. The second fabric panel is coupled to the first fabric panel. The second fabric panel has a first pair of apertures and a second pair of apertures. The first channel is positioned generally between a first one of the first pair of apertures and a first one of the second pair of apertures. The second channel is positioned generally between a second one of the first pair of apertures and a second one of the second pair of apertures. The cord is positioned through the first one of the first pair of apertures, through the first channel, out of the first one of the second pair of apertures, through the second one of the second pair of apertures, through the second channel, and out of the second one of the first pair of apertures.

According to some implementations of the present disclosure, a method of making a face mask includes forming a first fabric panel and forming a second fabric panel. The method further includes forming a first pair of apertures in the second fabric panel and forming a second pair of apertures in the second fabric panel. The method further includes coupling the first fabric panel to the second fabric panel about at least a portion of a perimeter of the face mask such that the face mask is inside-out. The method further includes inverting the face mask so the face mask is right-side out. The method further includes forming a first channel generally between a first one of the first pair of apertures and a first one of the second pair of apertures and forming a second channel generally between a second one of the first pair of apertures and a second one of the second pair of apertures. The method further includes positioning a cord through the first channel, out of the first one of the first pair of apertures, through the second one of the first pair of apertures, through the second channel, and out of the second one of the second pair of apertures.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1A is a front elevation view of an outside surface of a first fabric panel and an outside surface of a second fabric panel for use in making a face mask, according to some implementations of the present disclosure;

FIG. 1B is a front elevation view of an inside surface of the first fabric panel of FIG. 1A and an inside surface of the second fabric panel of FIG. 1A, according to some implementations of the present disclosure;

FIG. 2 is a perspective view of the first and second fabric panels of FIG. 1 where fabric patches of reinforcing material are attached to an inside-surface of the second fabric panel, according to some implementations of the present disclosure;

FIG. 3 is a perspective view of the first and second fabric panels of FIG. 2 where a first pair of apertures and a second pair of apertures are formed into the fabric patches and the second fabric panel, according to some implementations of the present disclosure;

FIG. 4 is a perspective view of the first and second fabric panels of FIG. 3 illustrating a first pair of aperture reinforcements and a second pair of aperture reinforcements being aligned with the first pair of apertures and the second pair of apertures, according to some implementations of the present disclosure;

FIG. 5 is a perspective view of the first and second fabric panels of FIG. 4 with the first pair of aperture reinforcements and the second pair of aperture reinforcements being respectively coupled to the first pair of apertures and the second pair of apertures, according to some implementations of the present disclosure;

FIG. 6 is a perspective view of the first and second fabric panels of FIG. 5 where the first fabric panel and the second fabric panel are attached together along a portion of a perimeter of the face mask such that the face mask is inside-out, according to some implementations of the present disclosure;

FIG. 7 is a perspective view of the face mask of FIG. 6 where the face mask is right-side out (e.g., not inside-out), according to some implementations of the present disclosure;

FIG. 8 is a perspective view of the right-side out face mask of FIG. 7 with first and second channels formed in the face mask, according to some implementations of the present disclosure;

FIG. 9 is a perspective view of the right-side out face mask of FIG. 8 with a cord strung through the first and second channels and a number of the apertures formed in the second fabric panel of the face mask, according to some implementations of the present disclosure;

FIG. 10 is a partial perspective view of the right-side out face mask of FIG. 9 with a fastener and/or cinching device coupled to a portion of the cord and with an end of the cord positioned through through one of the apertures, according to some implementations of the present disclosure;

FIG. 11 is a partial perspective view of the right-side out face mask of FIG. 10 illustrating two end portions of the cord being attached via a knot, according to some implementations of the present disclosure;

FIG. 12 is partial a perspective view of the right-side out face mask of FIG. 11 with the knot being positioned between the first fabric panel and the second fabric panel, according to some implementations of the present disclosure;

FIG. 13 is partial a perspective view of the right-side out face mask of FIG. 12 illustrating the first fabric panel being attached to the second fabric panel along a second portion of the perimeter of the face mask, according to some implementations of the present disclosure;

FIG. 14 is a rear perspective view of a fully assembled face mask, according to some implementations of the present disclosure;

FIG. 15 is a front perspective view of the fully assembled face mask of FIG. 14, according to some implementations of the present disclosure;

FIG. 16 is a front perspective view of the face mask of FIG. 14 illustrating a step in converting the face mask into a hair accessory, according to some implementations of the present disclosure;

FIG. 17 is a perspective view of the face mask of FIG. 14 illustrating a second step in converting the face mask into the hair accessory, according to some implementations of the present disclosure;

FIG. 18 is a front perspective view of a face mask that includes a pair of beads, according to some implementations of the present disclosure;

FIG. 19A is a partial bottom view of the face mask of FIG. 18 worn on a face of an individual with a cord that is loose, according to some implementations of the present disclosure; and

FIG. 19B is a partial bottom view of the face mask of FIG. 18 worn on the face of the individual with the cord that is relatively tighter as compared with FIG. 19A, according to some implementations of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

The present disclosure is directed to a face mask or face covering or the like that can be adjusted to fit about individuals having various sized faces and ears. The face mask can also be converted to a hair accessory (e.g., a hair tie, a scrunchie, etc., or the like) to be worn about a bundle of hair of the individual, about a wrist of the individual, or the like.

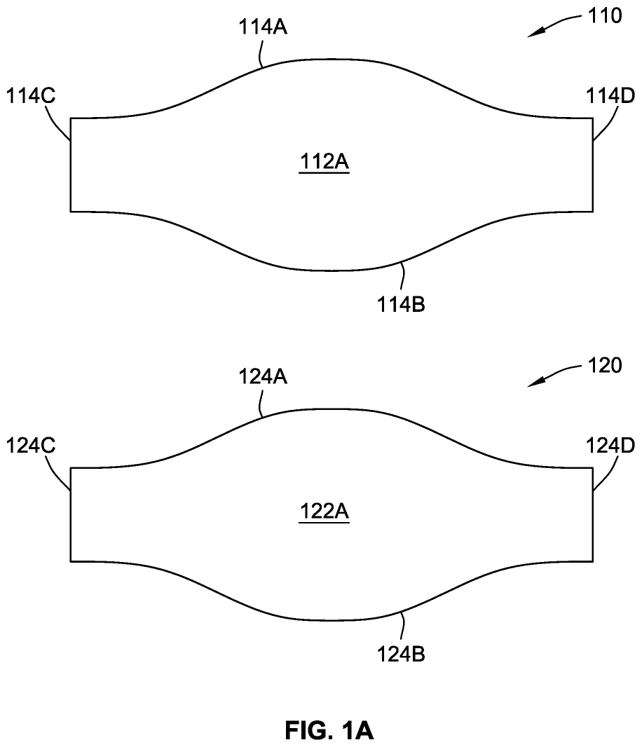

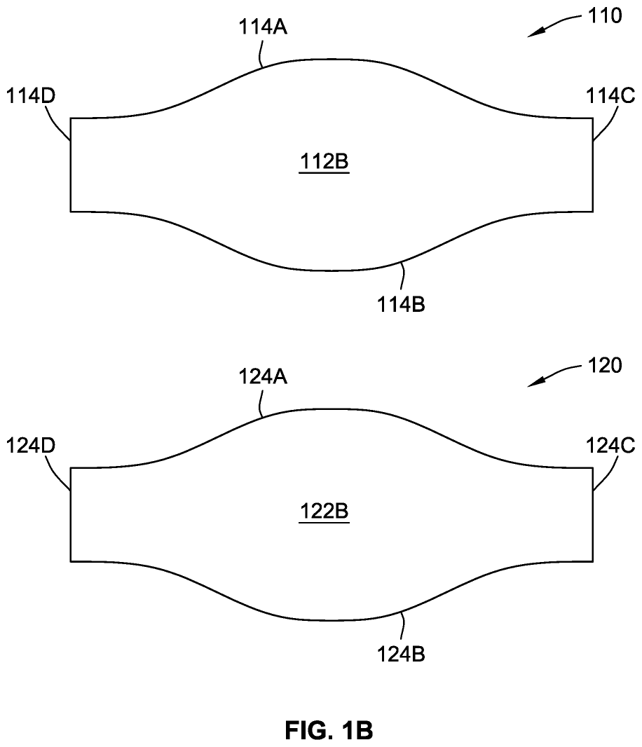

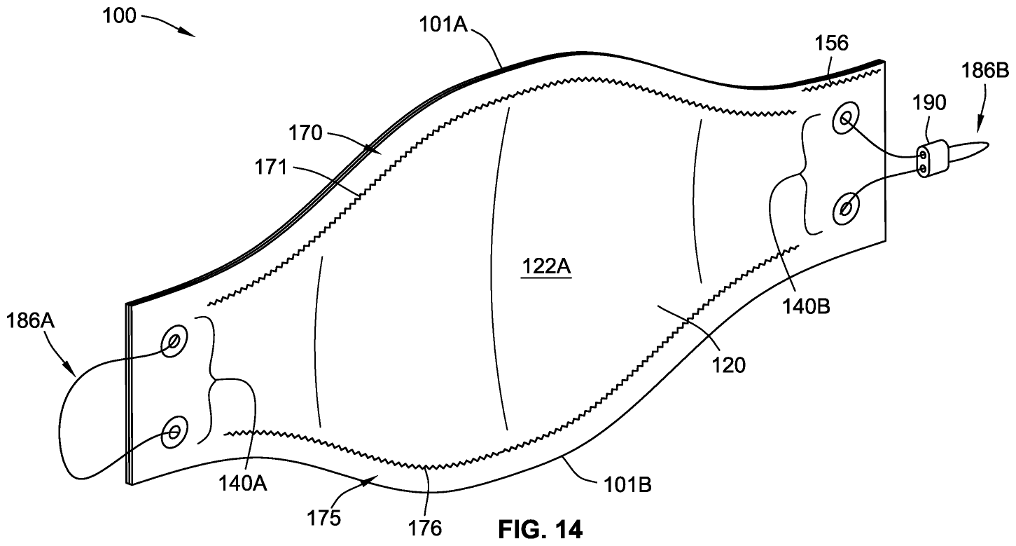

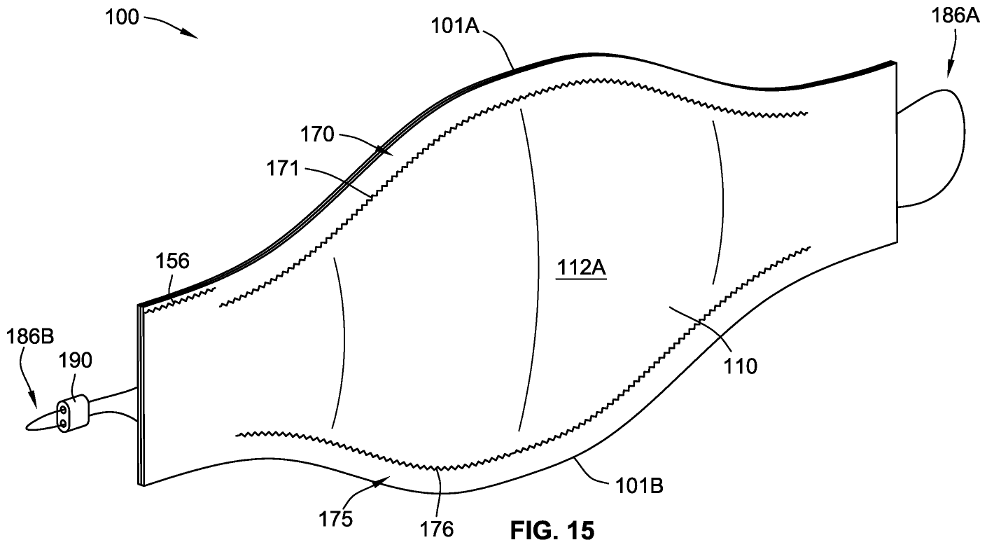

Referring generally to FIGS. 1 to 13, a method of making a device or face mask 100 (assembled views shown FIGS. 14 and 15) is illustrated. A rear or back perspective view of the assembled face mask 100 is shown in FIG. 14 and a front perspective view of the assembled face mask 100 is shown in FIG. 15. By rear it is meant to refer to the surface of the face mask 100 that contacts the face of the individual when worn on the face of the individual. Similarly, by front it is meant to refer to the surface of the face mask 100 that is visible and/or outwardly facing when the face mask 100 is worn on the face of the individual.

Referring to FIGS. 1A and 1B, a first fabric panel 110 and a second fabric panel 120 of the face mask 100 (FIGS. 14 and 15) are shown. FIG. 1A illustrates outside surfaces 112A, 122A of the first and second fabric panels 110, 120, respectively. Similarly, FIG. 1B illustrates inside surfaces 112B, 122B of the first and second fabric panels 110, 120, respectively. By outside it is meant to refer to surfaces of the face mask 100 that are completely or mostly (e.g., except for portions captured within a seam/stitch) external when the face mask 100 is assembled (FIGS. 14 and 15). Similarly, by inside it is meant to refer to surfaces of the face mask 100 that are internal or hidden when the face mask 100 is assembled (FIGS. 14 and 15).

The first fabric panel 110 has a perimeter that includes an upper edge 114A, a lower edge 114B, a left or first side edge 114C, and a right or second opposing side edge 114D. Similarly, the second fabric panel 120 has a perimeter that includes an upper edge 124A, a lower edge 124B, a left or first side edge 124C, and a right or second opposing side edge 124D.

As shown, the first fabric panel 110 is generally elongated between the first side edge 114C and the second side edge 114D and the second fabric panel 120 is generally elongated between the first side edge 124C and the second side edge 124D.

As shown, the first and second fabric panels 110, 120 have the same exact dimensions and size. In some alternative implementations, the first and second fabric panels can be different in size and/or shape (not shown).

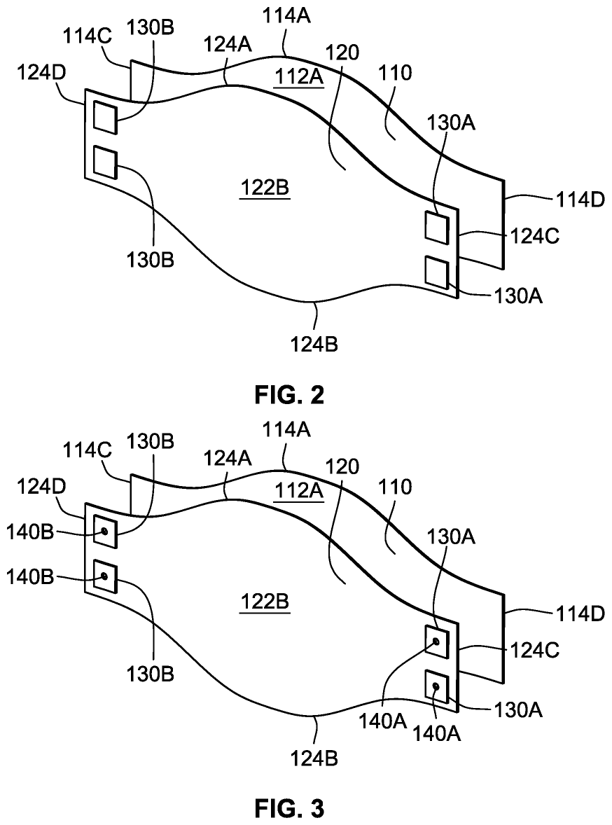

Referring to FIG. 2, with the first and second fabric panels 110, 120 ready for assembly, in some implementations, a first pair of fabric patches 130A are attached or coupled to the inside surface 122B of the second fabric panel 120 adjacent to the left edge 124C (with respect to the orientation of the second fabric panel 120 shown in FIG. 1A). Similarly, a second pair of fabric patches 130B are attached or coupled to the inside surface 122B of the second fabric panel 120 adjacent to the right edge 124D (with respect to the orientation of the second fabric panel 120 shown in FIG. 1A). It is noted that that the right and left edges 124C, 124D of the second fabric panel 120 are flipped in FIG. 2 as FIG. 2 illustrates the inside surface 122B (FIG. 1B) of the second fabric panel 120. The first and second pair of fabric patches 130A, 130B are also referred to as reinforcing patches or reinforcements that aid in reinforcing the second fabric panel 120.

Referring to FIG. 3, a first pair of apertures 140A are formed in second fabric panel 120 adjacent to the left edge 124C. In the implementations including the first pair of fabric patches 130A, the first pair of apertures 140A are also formed through the first pair of fabric patches 130A. Similarly, a second pair of apertures 140B are formed in second fabric panel 120 adjacent to the right edge 124D. In the implementations including the second pair of fabric patches 130B, the second pair of apertures 140B are also formed through the second pair of fabric patches 130B.

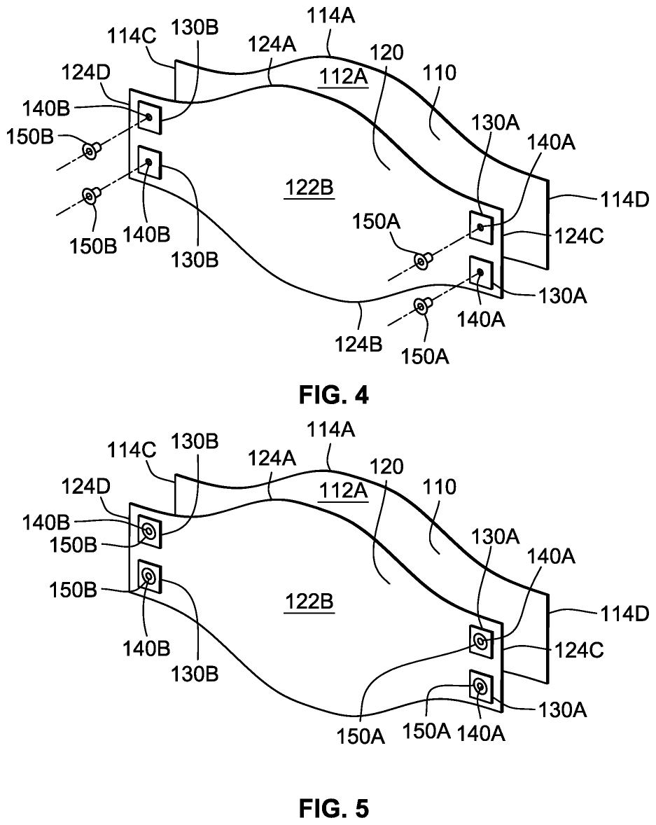

Referring to FIGS. 4 and 5, to aid in reinforcing the first and second pair of apertures 140A, 140B in the second fabric panel 120, a first pair of aperture reinforcements 150A is coupled to the second fabric panel 120 at the first pair of apertures 140A and a second pair of aperture reinforcements 150B is coupled to the second fabric panel 120 at the second pair of apertures 140B. As shown, the first and second pairs of aperture reinforcements 150A, 150B are and/or include a respective metal grommet and/or rivet for each aperture. Various other types of aperture reinforcements are contemplated, such as, for example, stitches, thread, fabric patches, glue, etc., or any combination thereof.

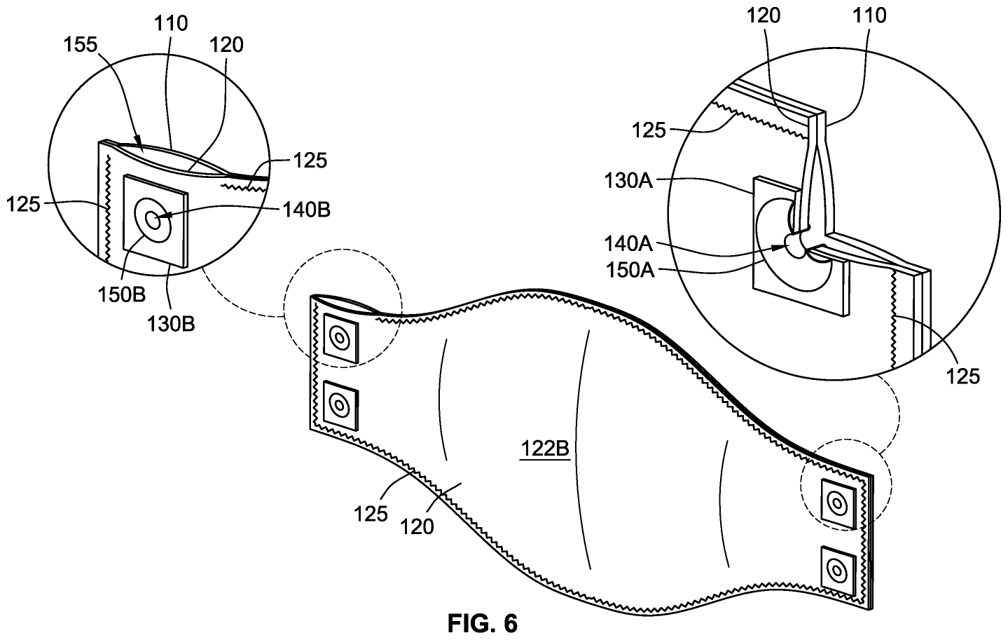

Referring to FIG. 6, with the first and second pairs of apertures 140A, 140B formed and reinforced, the first fabric panel 110 is attached and/or coupled to the second fabric panel 120. As shown, the first and second fabric panels 110, 120 are attached about a portion of a perimeter of each of the first and second fabric panels 110, 120 using a stitch/thread 125 that is stitched.

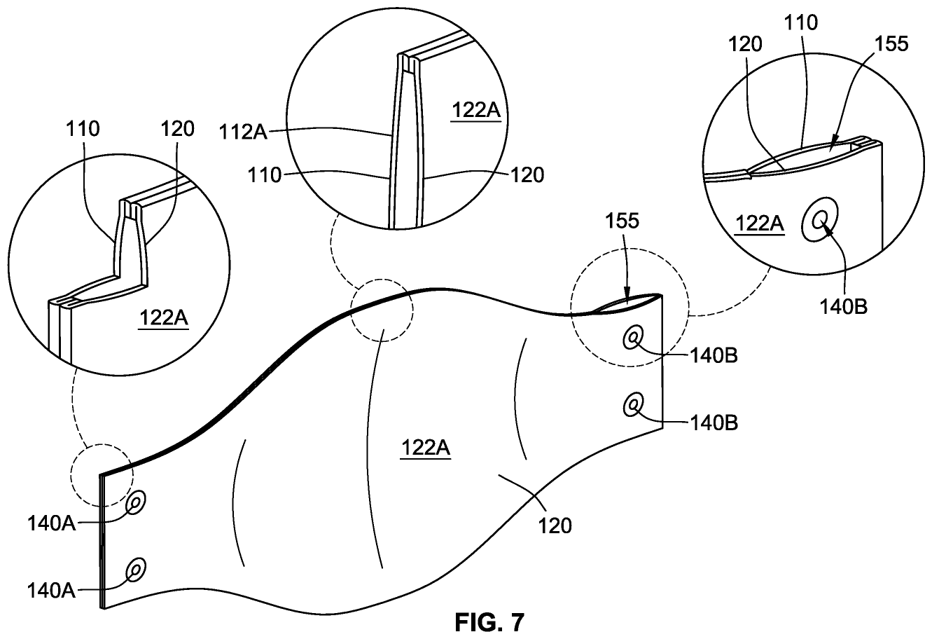

A portion of the perimeter is left unstitched/unattached such that the first and second fabric panels 110, 120 can be moved or pulled from being inside-out to being right-side out. Put another way, as shown in FIG. 6, the inside surface 122B of the second fabric panel 120 is exposed or on the outside. Similarly, the inside surface 112B (FIG. 1B) of the first fabric panel 110 is exposed or on the outside. To get the outside surfaces 112A and 122A of the first and second fabric panels 110, 120 to be exposed and on the outside of the face mask 100, the first and second fabric panels 110, 120 are pulled through and out of the gap 155, which results in what is shown in FIG. 7.

As shown in FIG. 7, the outside surfaces 112A, 122A of the first and second fabric panels 110, 120 are exposed and the first and second pairs of fabric patches 130A, 130B are hidden on the inside of the face mask 100. A portion of the first and second pairs of aperture reinforcements 150A, 150B are also exposed and provide access to the inside of the face mask 100 through the first and second pairs of apertures 140A, 140B.

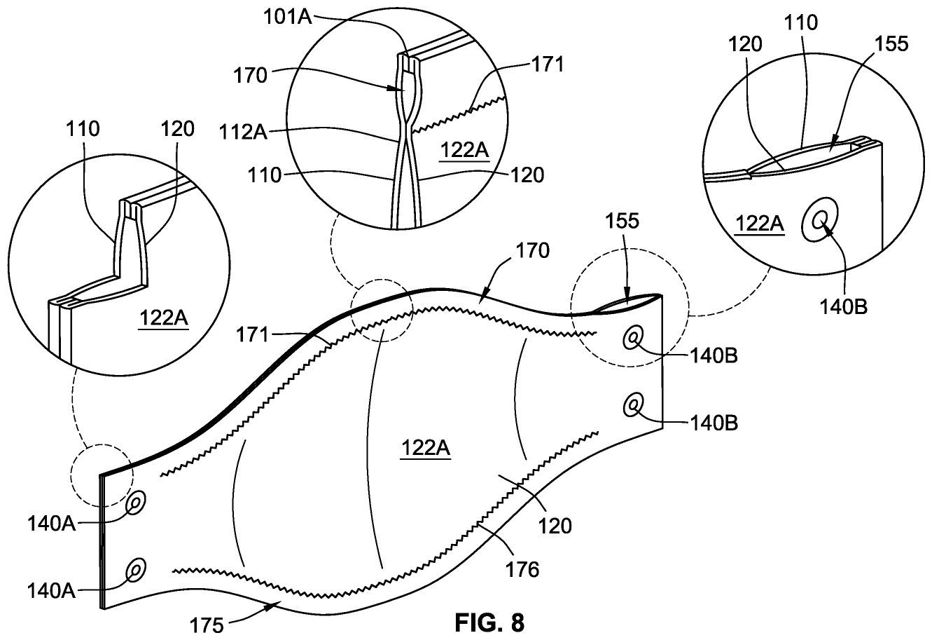

Referring to FIG. 8, a first channel 170 is formed in the face mask 100. The first channel 170 can be referred to as an internal or hidden first channel as the first channel 170 is internal to the face mask 100. The first channel 170 is formed by adding a stitch/thread 171 that attaches a portion of the first fabric panel 110 to a portion of the second fabric panel 120. The stitch/thread 171 is positioned/placed generally along and spaced from an upper edge 101A of the face mask 100. A width of the first channel 170 can be increased or decreased from what is shown by moving the stitch/thread 171 farther from or closer to the upper edge 101A of the face mask 100.

A second channel 175 is also formed in the face mask 100. The second channel 175 can be referred to as an internal or hidden second channel as the second channel 175 is internal to the face mask 100. The second channel 175 is formed by adding a stitch/thread 176 that attaches a portion of the first fabric panel 110 to a portion of the second fabric panel 120. The stitch/thread 176 is positioned/placed generally along and spaced from a lower edge 101B of the face mask 100. A width of the second channel 175 can be increased or decreased from what is shown by moving the stitch/thread 176 farther from or closer to the lower edge 101B of the face mask 100.

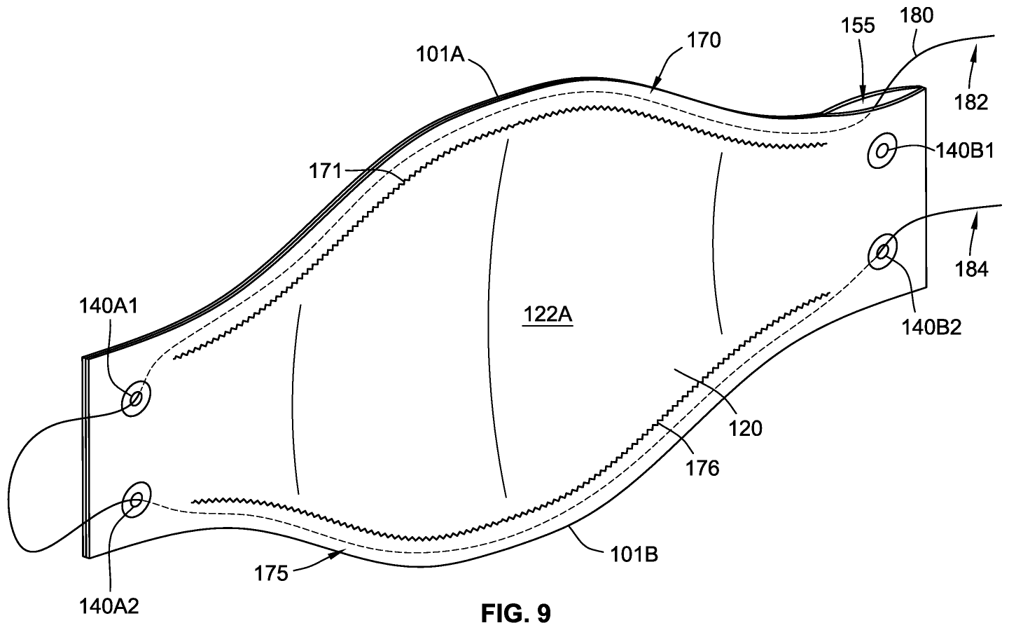

With the first and second channels 170, 175 formed, a cord 180 is threaded and/or positioned through the face mask 100 as shown in FIG. 9. The cord 180 can be an elastic cord that is stretchable with memory to return to an original length when the stretching force is removed. The cord 180 is a monolithic cord but can be made of more than one cords attached to coupled together. Specifically, the cord 180 is positioned into and/or through the gap 155, into and/or through the first channel 170, out of and/or through a first one 140A1 of the first pair of apertures 140A, into and/or through a second one 140A2 of the first pair of apertures 140A, into and through the second channel 175, and out of and/or through a second one 140B2 of the second pair of apertures 140B.

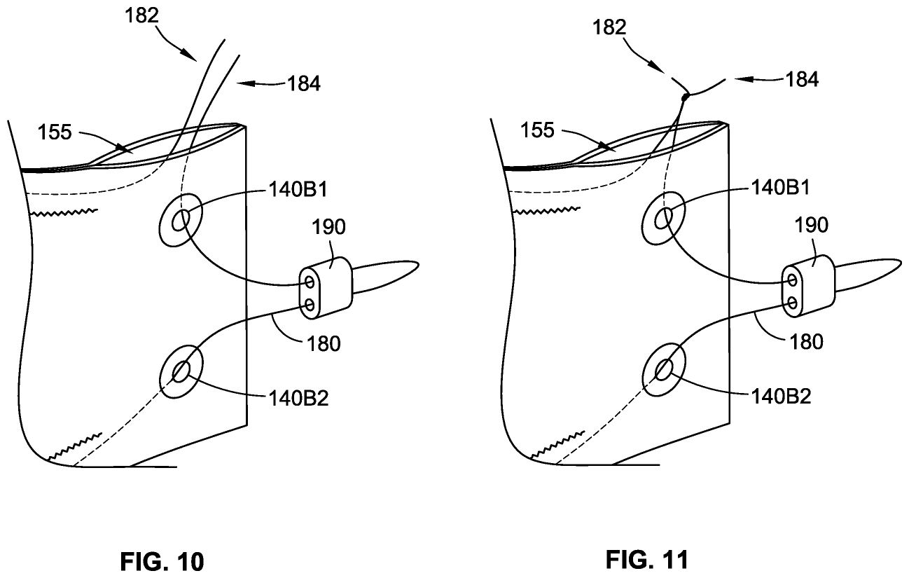

Referring to FIG. 10, in some implementations, a cinching device or a fastener 190 is attached to the cord 180. The cinching device or fastener 190 can be used to adjust an operational length of the cord 180 and/or for use in converting the face mask 100 into a hair accessory as described elsewhere herein. With the cord 180 coupled to and/or through the cinching device 190, the cord 180 is then positioned into and/or through a first one 140B1 of the second pair of apertures 140B.

The cinching device 190 can be or include a toggle fastener, a double toggle fastener, or any combination thereof. As shown, the cinching device 190 is a double toggle fastener. The double toggle fastener has two throughbores that permit the cord 180 to be positioned through one or both throughbores. The double toggle fastener also includes two actuators that are manually controllable by a user of the face mask such that each of the throughbores is separately controllable to permit the cord 180 to move therethrough and/or to prevent the cord 180 from readily moving therethrough.

Referring to FIG. 11, a first end portion 182 of the cord 180 is coupled to a second opposing end portion 184 of the cord 180. As shown, the first and second end portions 182, 184 are coupled via a knot. Various other methods for coupling the first and second end portions 182, 184 are contemplated, such as, for example, melting, ultrasonic welding, crimping fastener(s), braiding, gluing, etc., or any combination thereof.

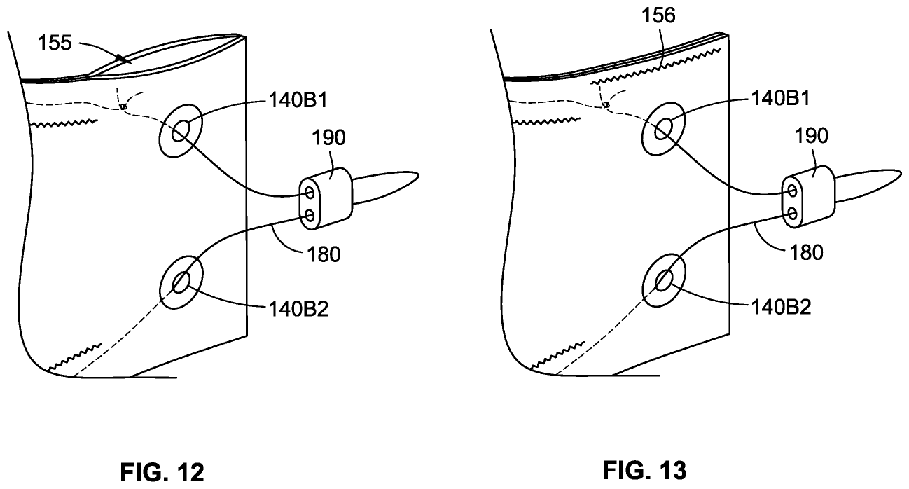

Referring to FIG. 12, with the first and second end portions 182, 184 coupled, the cord 180 is positioned back into the gap 155 and the gap 155 is then closed using a stitch/thread 156 as shown in FIG. 13.

Referring to FIGS. 14 and 15, with the gap 155 closed, a first portion of the cord 180 that extends from the first pair of apertures 140A defines and/or forms a first ear hook 186A. Similarly, a second portion of the cord 180 that extends from the second pair of apertures 140B defines and/or forms a second ear hook 186B. The size and/or length of the first and second ear hooks 186A, 186B can be modified by adjusting the cord 180 and/or the cinching device 190. IN some implementations, a second cinching device (not shown) can be coupled to the first eat hook 186A in the same, or similar, fashion that the cinching device 190 is coupled to the second ear hook 186B.

In some alternative implementations, a filter layer (not shown) can be positioned between the first fabric panel 110 and the second fabric panel 120 to aid in filtering of air passing through the face mask 100. In some such implementations, the filter layer can extend generally between the first channel 170 and the second channel 175. The filter layer can include any fabric or material or combination of materials to aid in the filtering of air.

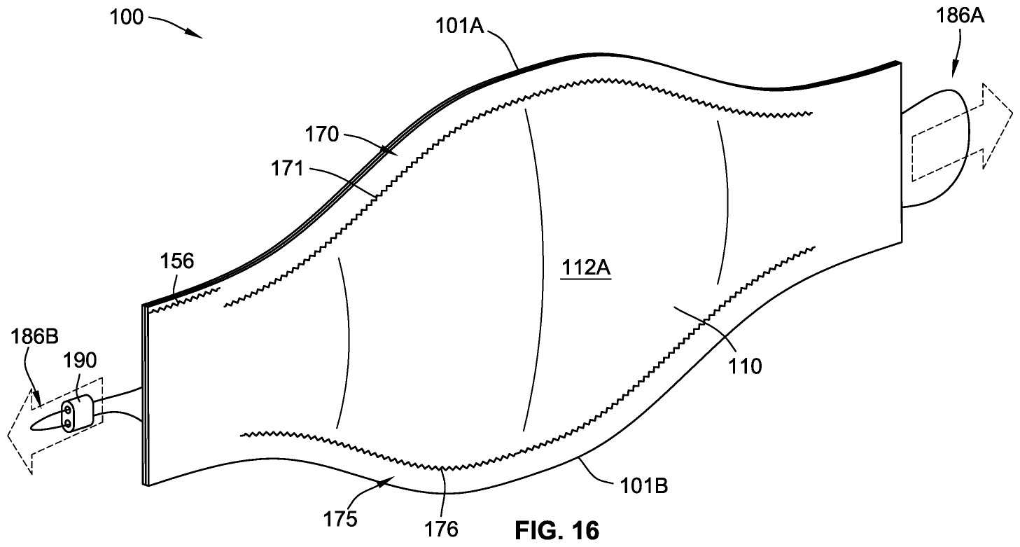

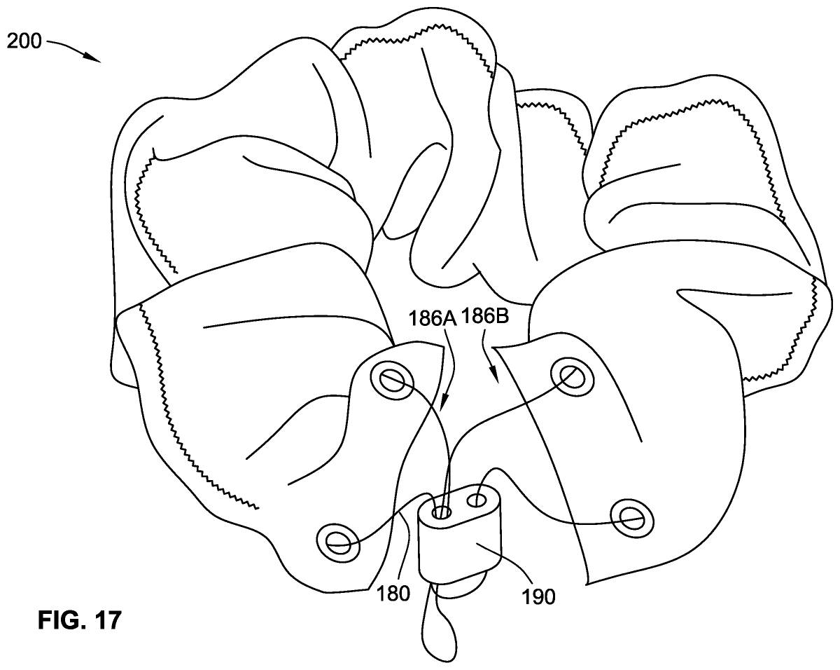

Referring to FIGS. 16 and 17, a method of converting the face mask 100 into a hair accessory 200 is shown. To convert the face mask 100 into the hair accessory 200, the first and second ear hooks 186A, 186B are pulled (FIG. 16) apart in the direction of the shown arrows. Then the first ear hook 186A is pinched and positioned into and/or through one of the throughbores of the cinching device 190. The tightness and/or diameter of the hair accessory 200 can be adjusted by pulling more or less of the first ear hook 186A through the cinching device 190.

Once the face mask 100 is converted into the hair accessory 200, the hair accessory 200 is able to hold a bundle of hair in a ponytail and/or be worn about a wrist or arm of an individual in the same, or similar, fashion as a rubber band.

While the cinching device 190 is shown as a double toggle fastener, in some other implementations, the cinching device 190 can be and/or include one or more hooks, one or more loops, one or more toggles, one or more double toggles, one or more magnets, one or more hook and loop fasteners, or any combination thereof.

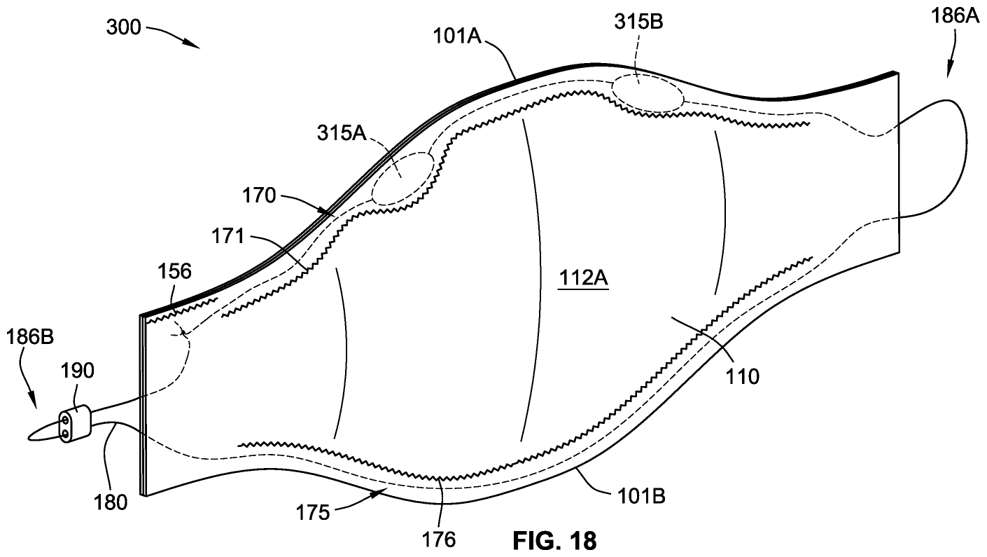

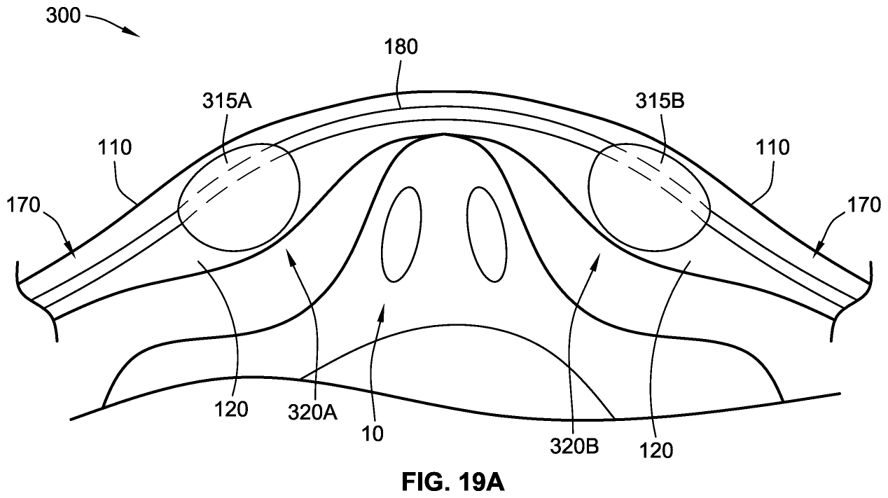

Referring to FIG. 18, a face mask 300 is shown that is the same as, or similar to, face mask 100 where like reference numbers are used for like components. As shown, the face mask 300 further includes, as compared with the face mask 100, a first bead 315A and a second bead 315B positioned in the first channel 170 and along the cord 180. The first and second beads 315A, 315B are spaced apart from each other. The spacing can be, for example, about 0.5 inches to about 4 inches, between about 1 inch and about 2.5 inches, or any other spacing.

The first bead 315A aids in causing a first bulge 320A of the second fabric panel 120 and the second bead 315B aids in causing a second bulge 320B of the second fabric panel 120. The first bulge 320A and the second bulge 320B aid in positioning the second fabric panel 120 closer to a face of an individual 10 wearing the face mask 300.

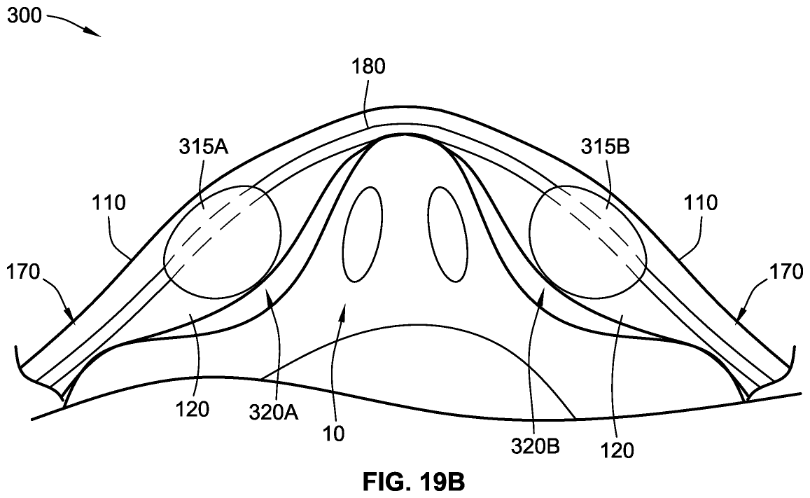

As shown in FIGS. 19A and 19B, when the individual 10 wears the face mask 300, the first bulge 320A is positioned adjacent to a first side of a nose of the individual 10 and the second bulge 320B is positioned adjacent to a second opposing side of the nose of the individual 10.

While specific shapes and sizes of the first and second beads 315A, 315B are shown, the first and/or second beads 315A, 315B can have any size and any shape to aid in pushing the second fabric panel 120 towards the face of the individual 10 when worn. As shown, the first and second beads 315A, 315B have a generally oblong shape with a throughhole configured to permit the cord 180 to pass therethrough. As the individual tightens the cord 180, for example, by cinching the cord and tightening the cord 180 with the cinching device 190, the first and second beads 315A, 315B are moved closer to the face of the individual 10 to aid in a tighter fitting of the face mask 300 about the nose of the individual 10.

The operation of the face mask 300 that is demonstrated in FIGS. 19A and 19B is the same, or similar, to the operation of the face mask 100 when the cord 180 is cinched. That is, the face mask 100 can be tightened to a face of an individual by cinching the 180.

While the present disclosure has been described with reference to one or more particular embodiments and implementations, those skilled in the art will recognize that many changes may be made thereto without departing from the spirit and scope of the present disclosure. Each of these embodiments and implementations and obvious variations thereof is contemplated as falling within the spirit and scope of the present disclosure, which is set forth in the claims that follow.

1. A device convertible between a face mask and a hair accessory, the device comprising:
a first fabric panel having an upper edge, a lower edge, a first side edge, and a second side edge;
a second fabric panel having an upper edge, a lower edge, a first side edge, and a second side edge, the second fabric panel being coupled to the first fabric panel about at least a portion of a perimeter of the device, the second fabric panel having a first pair of apertures adjacent to the first side edge of the second fabric panel and a second pair of apertures adjacent to the second side edge of the second fabric panel;
a first pair of aperture reinforcements coupled to the second fabric panel about the first pair of apertures and a second pair of aperture reinforcements coupled to the second fabric panel about the second pair of apertures to aid in reinforcing the first and second pairs of apertures in the second fabric panel;
a first channel positioned generally along at least a portion of the upper edge of the first fabric panel and at least a portion of the upper edge of the second fabric panel such that a first one of the first pair of apertures is in communication with a first one of the second pair of apertures via the first channel;
a second channel positioned generally along at least a portion of the lower edge of the first fabric panel and at least a portion of the lower edge of the second fabric panel such that a second one of the first pair of apertures is in communication with a second one of the second pair of apertures via the second channel; and
a cord positioned through the first one of the second pair of apertures, through the first channel, out of the first one of the first pair of apertures, through the second one of the first pair of apertures, through the second channel, and out of the second one of the second pair of apertures.

2. The device of claim 1, wherein a first portion of the cord that extends from the first pair of apertures defines a first ear hook and wherein a second portion of the cord that extends from the second pair of apertures defines a second opposing ear hook.

3.-4. (canceled)

5. The device of claim 2, further comprising a cinching device coupled to the first portion of the cord or the second portion of the cord to aid in adjusting a length of the first ear hook, a length of the second ear hook, or both.

6. The device of claim 2, further comprising a fastener that is coupled to first portion of the cord and configured to be coupled to the second portion of the cord to aid in converting the device from the face mask to the hair accessory.

7. The device of claim 6, wherein the coupling of the second portion of the cord to the fastener causes (i) at least a portion of the cord to stretch and (ii) at least a portion of the first fabric panel and at least a portion of the second fabric panel to bunch up.

8.-9. (canceled)

10. The device of claim 1, wherein the second fabric panel has substantially the same shape as the first fabric panel, and wherein the first fabric panel is generally elongated between the first side edge and the second side edge thereof and wherein the second fabric panel is generally elongated between the first side edge and the second side edge thereof.

11. (canceled)

12. The device of claim 1, further comprising a filter layer positioned between the first fabric panel and the second fabric panel to aid in filtering of air passing through the device, the filter layer extending generally from the first channel to the second channel.

13. (canceled)

14. The device of claim 1, further comprising a first bead positioned along the cord and within the first channel and a second bead positioned along the cord and within the first channel.

15. (canceled)

16. The device of claim 14, wherein the first bead is spaced from the second bead, the spacing between the first bead and the second bead being between about 0.5 inches and about 4 inches.

17.-18. (canceled)

19. The device of claim 14, wherein the first bead aids in causing a first bulge of the second fabric panel and the second bead aids in causing a second bulge of the second fabric panel, and wherein the first bulge and the second bulge aid in positioning the second fabric panel closer to a face of an individual wearing the device as a face mask.

20.-21. (canceled)

22. The device of claim 14, wherein the first bead has a generally oblong shape with a throughhole configured to permit the cord to pass therethrough.

23. The device of claim 1, wherein each of the first and second pairs of aperture reinforcements include a respective metal grommet and a respective fabric patch, each respective metal grommet being positioned at least partially through each respective fabric patch and the second fabric panel.

24.-26. (canceled)

27. The device of claim 1, wherein the cord is a monolithic elastic cord with a first end portion that is coupled to a second opposing end portion.

28.-31. (canceled)

32. A face mask comprising:
a first fabric panel;
a second fabric panel coupled to the first fabric panel, the second fabric panel having a first pair of apertures and a second pair of apertures;
a first channel positioned generally between a first one of the first pair of apertures and a first one of the second pair of apertures;
a second channel positioned generally between a second one of the first pair of apertures and a second one of the second pair of apertures; and
a cord positioned through the first one of the first pair of apertures, through the first channel, out of the first one of the second pair of apertures, through the second one of the second pair of apertures, through the second channel, and out of the second one of the first pair of apertures.

33. The face mask of claim 32, further comprising a cinching device coupled to the cord.

34. A method of making a face mask, the method comprising:
forming a first fabric panel;
forming a second fabric panel;
forming a first pair of apertures in the second fabric panel;
forming a second pair of apertures in the second fabric panel;
coupling the first fabric panel to the second fabric panel about at least a portion of a perimeter of the face mask such that the face mask is inside-out;
inverting the face mask so the face mask is right-side out;
forming a first channel generally between a first one of the first pair of apertures and a first one of the second pair of apertures;
forming a second channel generally between a second one of the first pair of apertures and a second one of the second pair of apertures; and
positioning a cord through the first channel, out of the first one of the first pair of apertures, through the second one of the first pair of apertures, through the second channel, and out of the second one of the second pair of apertures.

35. The method of claim 34, further comprising, subsequent to the positioning of the cord out of the second one of the second pair of apertures, positioning the cord through the first one of the second pair of apertures.

36. The method of claim 35, further comprising attaching a first end portion of the cord to a second end portion of the cord at an attachment location to form a continuous cord loop.

37. The method of claim 36, further comprising coupling the first fabric panel to the second fabric panel about at least a second portion of the perimeter of the face mask.

38. The method of claim 37, wherein the coupling the first fabric panel to the second fabric panel about the at least a second portion of the perimeter of the face mask aids in concealing the attachment location of the continuous cod loop within the face mask.

39.-40. (canceled)
